(19) United States
(12) Patent Application Publication
(10) Pub. No.: US 2025/0296398 A1
(43) Pub. Date: Sep. 25, 2025

(54) CLIP COMPONENT

(71) Applicant: VALEO SYSTEMES THERMIQUES, La Verriere (FR)

(72) Inventors: Joao CARVALHO, Auburn Hills, MI (US); Miguel Angel AGUILAR, San Luis Potosi (MX)

(73) Assignee: VALEO SYSTEMES THERMIQUES, La Verriere (FR)

(21) Appl. No.: 18/611,117

(22) Filed: Mar. 20, 2024

(51) Int. Cl. B60H 1/00

(52) U.S. Cl. CPC B60H 1/00521; B60H 1/00564

(57) ABSTRACT

A clip component for cooperation with a hole of a second element, including a base, a core portion protruding from the base in a first direction and a spring portion protruding from the base in the first direction, parallel to the core portion. The spring portion is adapted to be elastically deformed so as to move between a first position and a second position, the second position being such that the spring portion is positioned closer to the core portion than in the first position. The spring portion is adapted to restrict the movement of the second element with respect to the clip component. The core portion includes two side walls extending in a second direction, the spring portion being located at least partially between the two side walls. The base includes a resting surface for supporting the second element.

### TECHNICAL FIELD

The present invention relates to a connection between subcomponents of a cooling module, in particular to a clip component of the connection.

### BACKGROUND OF THE INVENTION

Generally, a vehicle can comprise a heat exchanger module configured to exchange heat with air. The heat exchanger module can be arranged in a front end of the vehicle in the flow of air. The heat exchanger module comprises various parts such as at least one heat exchanger, air duct and fan unit connected together. Further, the vehicle comprises a plurality of moving parts, such as engine and motor that generate vibrations upon operation. The vibrations generated by the plurality of the moving parts are transmitted to the heat exchanger module. Therefore, connection of the various parts in the heat exchanger module should be capable of withstanding the vibrations transmitted thereto from the plurality of moving parts.

### SUMMARY OF THE INVENTION

A clip component for cooperation with a hole of a second element, comprising: a base, a core portion protruding from the base in a first direction, a spring portion protruding from the base in the first direction, parallel to the core portion, the spring portion being adapted to be elastically deformed so as to move between a first position and a second position, the second position being such that the spring portion is positioned closer to the core portion than in the first position, the spring portion being adapted to restrict the movement of the second element with respect to the clip component when the core portion and the spring portion are within the hole and the spring portion is in the first position, wherein the core portion includes two side walls extending in a second direction, perpendicular to the first direction, and a middle wall extending perpendicularly to the two side walls so as to connect them, the spring portion being located at least partially between the two side walls, wherein the base includes a resting surface for supporting the second element when the core portion and the spring portion are within the hole of the second element and the spring portion is in the first position, wherein the resting surface is distanced from the base in the first direction to be arranged closer to the second element than the base when the clip component is inserted into the hole.

In one example, the resting surface is arranged adjacent to the core portion so that it is adjacent to the hole of the second element when the clip component is connected to the second element.

In one example, the spring portion includes a locking portion extending in a second direction, perpendicular to the first direction.

In one example, the locking portion includes a locking surface extending in the second direction and facing the base.

In one example, the locking portion includes a guiding surface sloping towards the core portion as it extends farther away from the base.

In one example, the first position of the spring portion corresponds to a relaxed state in which the spring portion is not elastically deformed.

In one example, the spring portion includes a first spring arm and a second spring arm arranged oppositely to each other so that the core portion is arranged between the first spring arm and the second spring arm.

In one example, the clip component has a symmetrical shape with the symmetry plane extending through the core portion between the first spring arm and the second spring arm.

In one example, both the first spring arm and the second arm spring slope away from the core portion as they protrude from the base.

In one example, the first spring arm slopes away from the core portion in the opposite direction than the second arm spring as they protrude from the base.

In one example, the middle wall connects center portions of the two side walls.

In one example, the core portion has an acute portion for facilitating insertion into the hole of the second element.

In one example, the core portion includes two side walls extending in the second direction, and a middle wall extending perpendicularly to the two side walls so as to connect them, the spring portion being located at least partially between the side walls, wherein the two side walls have acute portions facilitating insertion into the hole of the second element.

Another object of the invention is a connection assembly comprising a first element with a bracket including a hole, and a second element including a clip component with a base, a core portion protruding from the base in a first direction, a spring portion protruding from the base in the first direction, parallel to the core portion, the spring portion being adapted to be elastically deformed so as to move between a first position and a second position, the second position being such that the spring portion is positioned closer to the core portion than in the first position, the spring portion being adapted to restrict the movement of the second element with respect to the first element when the core portion and the spring portion are within the hole and the spring portion is in the first position, wherein the core portion includes two side walls extending in a second direction, perpendicular to the first direction, and a middle wall extending perpendicularly to the two side walls so as to connect them, the spring portion being located at least partially between the two side walls, wherein the base includes a resting surface for supporting the second element when the core portion and the spring portion are within the hole of the second element and the spring portion is in the first position, wherein the resting surface is distanced from the base in the first direction to be arranged closer to the second element than the base when the clip component is inserted into the hole.

Another object of the invention is cooling module comprising an air duct with a bracket including a hole, and a radiator including a clip component with a base, a core portion protruding from the base in a first direction, a spring portion protruding from the base in the first direction, parallel to the core portion, the spring portion being adapted to be elastically deformed so as to move between a first position and a second position, the second position being such that the spring portion is positioned closer to the core portion than in the first position, the spring portion being adapted to restrict the movement of the air duct with respect to the radiator when the core portion and the spring portion are within the hole and the spring portion is in the first position, wherein the core portion includes two side walls extending in a second direction, perpendicular to the first direction, and a middle wall extending perpendicularly to the two side walls so as to connect them, the spring portion being located at least partially between the two side walls, wherein the base includes a resting surface for supporting the second element when the core portion and the spring portion are within the hole of the second element and the spring portion is in the first position, wherein the resting surface is distanced from the base in the first direction to be arranged closer to the second element than the base when the clip component is inserted into the hole.

### BRIEF DESCRIPTION OF DRAWINGS

The present invention will be described in greater detail below with reference to the drawings. In the drawings:

FIG. 1 shows a cooling module in a perspective view;

FIG. 2 shows a portion of the cooling module with a clip component inside a bracket of an air duct;

FIG. 3 shows the clip component in a perspective view;

FIG. 4 shows the clip component in another perspective view;

FIG. 5 shows the bracket without the clip component;

FIG. 6 shows another view of the bracket of FIG. 5;

FIG. 7 shows another perspective view of the clip component inside the bracket; and

FIG. 8 shows a cross-sectional of the clip component inside the bracket.

### DETAILED DESCRIPTION OF THE INVENTION

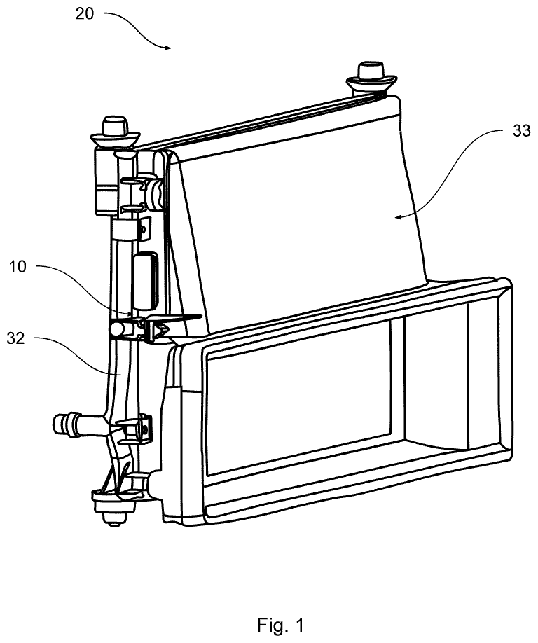

FIG. 1 shows a cooling module 20 in a perspective view. The cooling module 20 can be a part of a vehicle, and be intended to cool a heat exchange fluid used in a heat exchange loop. Subcomponents of the cooling module 20 can be connected to each other to form a robust unit. The subcomponents can include a radiator 32 and an air duct 33. A clip component 10 can be used to connect the subcomponents together, as it will be explained further in the description.

FIG. 2 shows a portion of the cooling module 20 with a clip component 10 inside a bracket 34 of the air duct 33. In this example, the clip component 10 is arranged on the radiator 32.

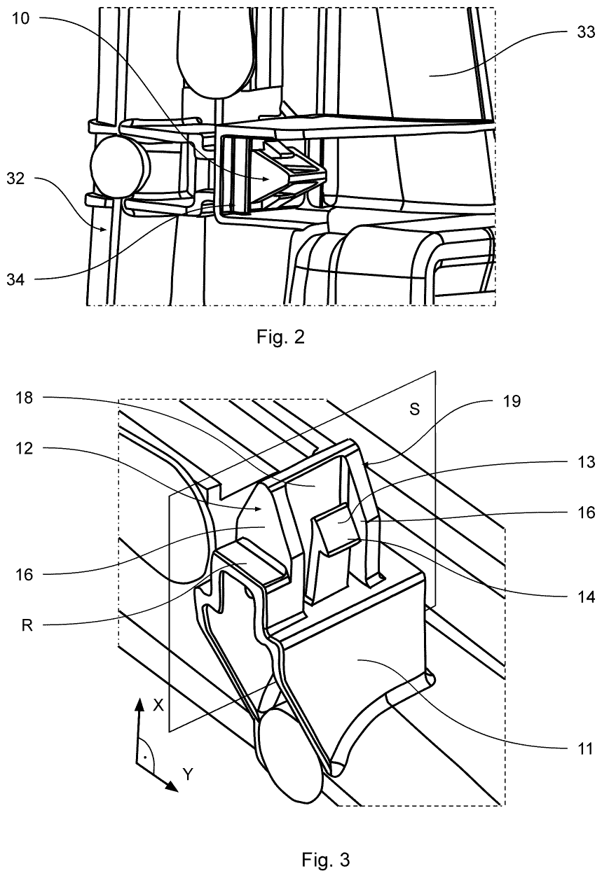

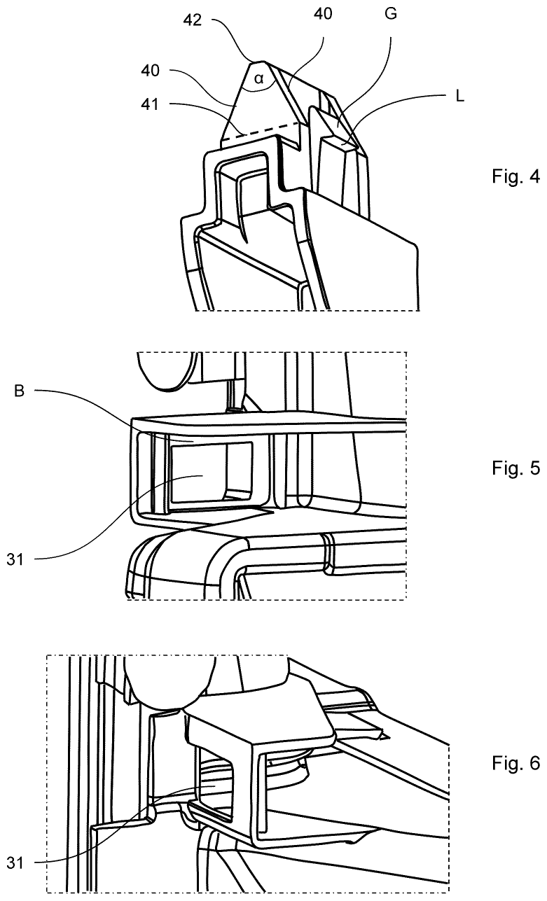

FIG. 3 and FIG. 4 show the clip component 10, isolated from the bracket 34, in two different perspective views. The clip component 10 can be arranged on a first element 1, for example on the radiator 32, in order to enable connection to a second element 2, for example the air duct 33. For clarity, the first element 1 and the second element 2 will be referenced in the further description as incorporating respectively the clip component 10 and the bracket 34.

The clip component 10 includes a base 11, a core portion 12 protruding from the base 11 in a first direction X, and a spring portion 13 protruding from the base 11 in the first direction X. In the shown example, the spring portion 13 protrudes from the base 11 substantially parallel to the core portion 12. In other words, in one example, the spring portion 13 can be slightly oblique with respect the core portion 12, while still generally extending along the core portion 12 in the first direction X. The base 11 can have a flat surface from which the core portion 12 and other subcomponents extend.

The spring portion 13 is adapted to be elastically deformed so as to move between a first position and a second position. In the shown example, a terminal end of the spring portion 13 is free and is not attached to any other component of the first element 1. The second position is such that the spring portion 13 is positioned closer to the core portion 12 than in the first position. For example, the spring portion 13 can be bent towards the core portion 12, effectively displacing the terminal end of the spring portion 13 in the desired direction.

The second element 2 can include a bracket 34 in which the hole 31 is arranged.

The spring portion 13 is adapted to restrict the movement of the second element 2 with respect to the clip component 10 when the core portion 12 and the spring portion 13 are within the hole 31 of the second element 2 and the spring portion 13 is in the first position. In other words, once the spring portion 13 is inserted in the hole 31, it prevents at least partially a relative movement of the first element 1 and the second element 2. For example, the spring portion 13 can include a locking portion 14 extending in a second direction Y, perpendicular to the first direction X. The locking portion 14 can be a dedicated, shaped portion of the spring portion 13 enabling desirable contact between the spring portion 13 and the second element 2, in particular having a shape that will prevent the second element 2 from moving in the first direction X away from the first element 1. In one example, the locking portion 14 includes a locking surface L extending in the second direction Y and facing the base 11. In such case, the locking surface L is intended to face the surface of the bracket 34 around the hole 31, for instance by being substantially parallel to thereto.

In one example, the locking portion 14 includes a guiding surface G sloping towards the core portion 12 as it extends farther away from the base 11. The guiding surface G then facilitates insertion of the spring portion 13 into the hole 31 while at the same time ensuring a force which will bend the spring portion 13 towards the core portion 12.

In one example, the base 11 includes a resting surface R for supporting the second element 2 when the core portion 12 and the spring portion 13 are within the hole 31 of the second element 2 and the spring portion 13 is in the first position.

In one example, the resting surface R is distanced from the base 11 in the first direction X to be arranged closer to the second element 2 than the base 11 when the clip component 10 is inserted into the hole 31.

In one example, the resting surface R is arranged adjacent to the core portion 12 so that it is adjacent to the hole 31 of the second element 2 when the clip component 10 is connected to the second element 2. In one example, the resting surface R supports only a portion of the area in the vicinity of the hole 31. Such selective positioning enables to alleviate any undesired stresses related to the connection without negatively affecting the dimensioning and/or packaging of the assembly and related manufacturing costs. In one example, the resting surface R is created by elevating a portion of the base 11, thereby creating an unoccupied volume below it when looked in the first direction X relative to the terminal ends of the core portion 12 and the spring portion 13, limited from opposite sides by the walls extending in the second direction Y and from one side by a portion of the core portion 12.

In general the base 11 can cooperation of the portion of the second element 2, in particular of the bracket 34, when the thickness thereof is smaller than the distance between the locking portion 14 and the base 11 in the first direction X.

In one example, the first position of the spring portion 13 corresponds to a relaxed state in which the spring portion 13 is not elastically deformed. Consequently, when the spring portion 13 is within the hole 31 of the second element 2, the edges of the hole 31 do not need to be in contact with the part of the spring portion 13 between the locking portion 14 and the base 11.

In one example, the spring portion 13 includes a first spring arm 15 and a second spring arm 16 arranged oppositely to each other so that the core portion 12 is arranged between the first spring arm 15 and the second spring arm 16. The first spring arm 15 can be identical in shape to the second spring arm 16, with opposite arrangement with respect to the core portion 12.

The clip component 10 can have a symmetrical shape with the symmetry plane S extending through the core portion 12 between the first spring arm 15 and the second spring arm 16. Consequently, the core portion 12 can have a symmetrical shape.

In one example, both the first spring arm 15 and the second arm spring 16 slope away from the core portion 12 as they protrude from the base 11.

In one example, the first spring arm 15 slopes in the opposite direction than the second arm spring 16 as they protrude from the base 11.

In one example, the core portion 12 includes two side walls 17 extending in the second direction Y and a middle wall 18 extending perpendicularly to the two side walls 17 so as to connect them, the spring portion 13 being located at least partially between the two side walls 17. The two side walls 17 and the middle wall 18 extend from the base 11 in the first direction X.

In one example, the middle wall 18 connects center portions of the two side walls 17.

In one example, the core portion 12 has an acute portion 19 for facilitating insertion into the hole 31 of the second element 2. The acute portion 19 can include a surface that is parallel, or surfaces that are parallel, to the guiding surface G of a corresponding spring portion 13 or spring arm 15, 16. The acute portion can be of substantially triangular shape when viewed from a side, e.g. when viewed along the symmetry plane S. The substantially triangular shape can be understood as having two arms 40 of substantially the same length. In one example, a third arm 41 virtually connecting bottom ends of the two arms 40 of the shape is substantially of the same length as of each arm 40. In one example, an angle α between the two arms can be between 30 and 75 degrees. In one example, the angle α is 60 degrees. A tip 42 of the shape serving as a meeting point of the ends of the two arms 40 is relatively narrow to further facilitate insertion and minimize the chance of blocking collision between the first element 1 and the second element 2. For example, width of the tip measured in the second direction Y is at least 4 times smaller than of analogously measured width of the resting surface R and/or of analogously measured maximum width of core portion 12. In one example, the middle wall 18 incorporates the tip 42 so that the height of the core portion 12 measured in the first direction X from the base 11 is constant in the second direction Y.

In one example, the core portion 12 includes two side walls 17 extending in the second direction Y, and the middle wall 18 extending perpendicularly to the two side walls 17 so as to connect them, the spring portion 13 being located at least partially between the side walls 17, wherein the two side walls 17 have acute portions 19 facilitating insertion into the hole 31 of the second element 2.

FIG. 5 and FIG. 6 shows the bracket 34 without the clip component 10 in two different views. The hole 31 of an second element 2 can be of rectangular shape. The hole 31 of an second element 2 can be surrounded by a support surface B on which the locking surface L of the spring portion 13 can rest and thus block the movement of the clip component 10.

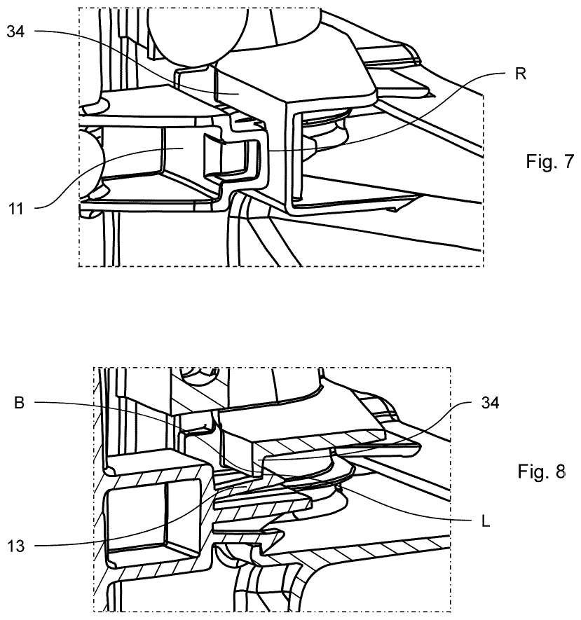

FIG. 7 shows another perspective view of the clip component 10 inside the bracket 34, with FIG. 8 showing a cross-sectional view of the arrangement of FIG. 7. The Locking surface of the spring portion 13 is resting on the support surface B of the bracket 34.

In general, to connect the first element 1 with the second element 2, the clip component 10 with the spring portion 13 in the first position is put within the hole 31 of the bracket 34. As the clip component 10 is moved in the first direction X towards the second element 2, the core portion 12 and the spring portion 13 (the first spring arm 15 and the second spring arm 16) move within the hole. The guiding surface G of the spring portion 13 is in contact with the edge of the hole 31 and because it is sloped, the whole spring portion 13 bends towards the core portion 12 to reach the second position. Once the whole guiding surface G enters through the hole 31, the spring portion 13 is allowed to move back (spring back, as it was elastically deformed) back to the first position so that the support surface B moves along the locking surface L. Once the connection process is complete, the locking surface L facing the support surface B prevents the clip component 10 from detaching from the bracket 34. Naturally, when the first spring arm 15 and the second arm 16 are present, their guiding surfaces G work with respective edges of the hole 31 to move between their respective first and second positions in an analogous manner.

The clip component 10 according to the invention allows to reduce space required for securely connecting the first and second elements 1, 2 because of a relatively small dimensional requirements of the whole assembly.

1. A clip component for cooperation with a hole of a second element, comprising:
a base,
a core portion protruding from the base in a first direction,
a spring portion protruding from the base in the first direction, parallel to the core portion,
the spring portion being adapted to be elastically deformed so as to move between a first position and a second position, the second position being such that the spring portion is positioned closer to the core portion than in the first position,
the spring portion being adapted to restrict the movement of the second element with respect to the clip component when the core portion and the spring portion are within the hole and the spring portion is in the first position, wherein the core portion includes two side walls extending in a second direction, perpendicular to the first direction, and a middle wall extending perpendicularly to the two side walls so as to connect them, the spring portion being located at least partially between the two side walls, wherein the base includes a resting surface for supporting the second element when the core portion and the spring portion are within the hole of the second element and the spring portion is in the first position, wherein the resting surface is distanced from the base in the first direction to be arranged closer to the second element than the base when the clip component is inserted into the hole.

2. The clip component according to claim 1, wherein the resting surface is arranged adjacent to the core portion so that it is adjacent to the hole of the second element when the clip component is connected to the second element.

3. The clip component according to claim 1, wherein the spring portion includes a locking portion extending in a second direction, perpendicular to the first direction.

4. The clip component according to claim 3, wherein the locking portion includes a locking surface extending in the second direction and facing the base.

5. The clip component according to claim 3, wherein the locking portion includes a guiding surface sloping towards the core portion as it extends farther away from the base.

6. The clip component according to claim 1, wherein the first position of the spring portion corresponds to a relaxed state in which the spring portion is not elastically deformed.

7. The clip component according to claim 1, wherein the spring portion includes a first spring arm and a second spring arm arranged oppositely to each other so that the core portion is arranged between the first spring arm and the second spring arm.

8. The clip component according to claim 7, having a symmetrical shape with the symmetry plane extending through the core portion between the first spring arm and the second spring arm.

9. The clip component according to claim 7, wherein both the first spring arm and the second arm spring slope away from the core portion as they protrude from the base.

10. The clip component according to claim 9, wherein the first spring arm in the opposite direction than the second arm spring as they protrude from the base.

11. The clip component according to claim 1, wherein the middle wall connects center portions of the two side walls.

12. The clip component according to claim 1, wherein the core portion has an acute portion for facilitating insertion into the hole of the second element.

13. The clip component according to claim 1, wherein the core portion includes two side walls extending in the second direction, and a middle wall extending perpendicularly to the two side walls so as to connect them, the spring portion being located at least partially between the side walls, wherein the two side walls have acute portions facilitating insertion into the hole of the second element.

14. A connection assembly comprising
a first element with a bracket including a hole, and
a second element including a clip component with
a base,
a core portion protruding from the base in a first direction,
a spring portion protruding from the base in the first direction, parallel to the core portion, the spring portion being adapted to be elastically deformed so as to move between a first position and a second position, the second position being such that the spring portion is positioned closer to the core portion than in the first position,
the spring portion being adapted to restrict the movement of the second element with respect to the first element when the core portion and the spring portion are within the hole and the spring portion is in the first position, wherein the core portion includes two side walls extending in a second direction, perpendicular to the first direction, and a middle wall extending perpendicularly to the two side walls so as to connect them, the spring portion being located at least partially between the two side walls, wherein the base includes a resting surface for supporting the second element when the core portion and the spring portion are within the hole of the second element and the spring portion is in the first position, wherein the resting surface is distanced from the base in the first direction to be arranged closer to the second element than the base when the clip component is inserted into the hole.

15. A cooling module comprising
an air duct with a bracket including a hole, and
a radiator including a clip component with
a base,
a core portion protruding from the base in a first direction,
a spring portion protruding from the base in the first direction, parallel to the core portion, the spring portion being adapted to be elastically deformed so as to move between a first position and a second position, the second position being such that the spring portion is positioned closer to the core portion than in the first position,
the spring portion being adapted to restrict the movement of the air duct with respect to the radiator when the core portion and the spring portion are within the hole and the spring portion is in the first position, wherein the core portion includes two side walls extending in a second direction, perpendicular to the first direction, and a middle wall extending perpendicularly to the two side walls so as to connect them, the spring portion being located at least partially between the two side walls, wherein the base includes a resting surface for supporting the second element when the core portion and the spring portion are within the hole of the second element and the spring portion is in the first position, wherein the resting surface is distanced from the base in the first direction to be arranged closer to the second element than the base when the clip component is inserted into the hole.
